(19) United States
(12) Patent Application Publication
(10) Pub. No.: US 2005/0141016 A1
(43) Pub. Date: Jun. 30, 2005

(54) Image printing device incorporating pause capability and method of operating the same

(75) Inventor: Jeong-soo Han, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/019,229

(22) Filed: Dec. 23, 2004

(30) Foreign Application Priority Data
Dec. 27, 2003 (KR) 2003-98230

(51) Int. Cl. G06F 15/00

(52) U.S. Cl. 358/1.14; 358/1.1

(57) ABSTRACT

A method of operating an image printing device including generating output data to form an image by interpreting and processing received input data, holding while a pause option, is activated, and forming the image using the output data and printing the formed image when the pause option is deactivated. The output data is generated even while the pause option is activated. The pause operation further includes determining whether the print cancel option is activated, canceling the print operation and deleting the input data from a memory when it is determined that the printing cancel option is activated, and holding until the pausing option is deactivated when it is determined the print cancel option is deactivated.

### CROSS-REFERENCE TO RELATED APPLICATIONS

This application claims the benefit of Korean Patent Application No. 2003-98230, filed on Dec. 27, 2003, in the Korean Intellectual Property Office, the disclosure of which is incorporated herein in its entirety by reference.

### BACKGROUND OF THE INVENTION

1. Field of the Invention

The present invention relates to an image printing device, more particularly to an image printing device incorporating pause capability.

2. Description of the Related Art

As digital technology has improved, various devices capable of transmitting/receiving various image information as well as transmitting/receiving simple voice information have been developed. Particularly, an image printing device such as a printer has been remarkably advanced in the aspect of processing and printing speed. Therefore, the data amount which can be processed per hour is increased, and image information of a plurality of sheets of paper can be processed and printed out in a short period of time.

In addition, network technology for mutually connecting various electronic products has been advanced. Therefore, contrary to the conventional art where one printer is connected to one computer, a group of computers are able to share one printer. In this case, input data transmitted from each computer is forwarded to the single printer through a network, and the forwarded input data is received and processed by the single printer. In the meantime, output data, which is used to form an image to be printed on paper, is generated. The output data is generated in bitmap form by the conventional art, and in the case of 600 dpi resolution, the data occupies memory capacity of about 4 Mb through 16 Mb for A4 size paper. Therefore, the image printing device shared through the network requires a large memory capacity to temporarily store the output data. When input data is received from many users at the same time, the memory device may temporarily store subsequent input data while processing previously received input data.

FIG. 1 is a flow chart for illustrating the operation of an image printing device according to the conventional art.

First, the printing device processes input data received from a user to form an image (S110). The input data can be formed of files in various forms, such as an electronic document in a predetermined form. The image printing device analyzes the received file, and sets basic print information such as print settings, resolutions, etc.

Then, a storage region to store the generated output data is set (S130). The storage region is allocated in a predetermined region of a memory included in the image printing device. Then, the image printing device generates the output data to form images (S150). The output data plays a role as a mask used to form images by the image printing device. That is, if the image printing device is a laser type, the output data is transferred on a transfer roller and images are generated on a sheet of paper by a developing roller. In contrast, if the image printing device is an ink jet type, an ink jet head is controlled according to the output data to print the image on a sheet of paper.

The print operation using the stored output data is then performed (S170). Any printing technique applied to various image printing devices according to the conventional art can be used in the print operation. Finally, it is determined whether there is data to be additionally printed, and if so, all operations are repeated from the beginning (S190).

In the conventional art, however, when the print data from a user is transmitted to the image printing device, it is batch-processed and printed. In other words, after the print data is transmitted to the image printing device, operations such as generating output data, storing output data, forming images, printing and the like are continually processed by the image printing device. Methods of stopping the print operation, which is batch-processed, include stopping due to an error of the image printing device itself, resetting of the device by a user, using an operation cancel button on the device, etc. Besides, although the user can query the network administrator to cancel the printing operation which is delivered from the local computer, the printing operation can be cancelled only before the operation starts and, once the operation starts, it is difficult to cancel. That is, in the conventional art, when a user wants to stop the print operation of the device by some immediate need of the user, after the user sends input data to the image printing device, there is no function to perform the stopping efficiently.

The situation can work as a serious disadvantage in actual use of the image printing device. For convenience of explanation, consider when a user prints a document including a plurality of pages. Sometimes, the user may print a few pages to confirm the printing status (e.g. left/right margins, font styles, etc.) before he prints out the rest of the pages. In this case, the whole document can be simultaneously sent to the image printing device and printed before the user realizes what has happened, unless the user activated the option to print only the first few sheets at the beginning of the first printing. Particularly, these disadvantages waste disposable goods such as paper, ink, and toner due to the data delivery speed of high-speed networks and large capacity of the latest image printing devices.

Furthermore, consider when a user uses a duplex printing function. When the user starts printing with the duplex printing function activated, second hand paper sheets can be loaded in a paper container of the printing device. In this case, the user should cancel the print operation and reprint after loading new sheets of paper, and many disposable goods are wasted before the print operation is stopped.

Therefore, an image printing device including a capability to pause operation by a user's command while batch processing the input data is required.

### SUMMARY OF THE INVENTION

Accordingly, it is an aspect of the present invention to provide a method of operating an image printing device to make the image printing device stop the printing operation while input data including a plurality of pages sent to the image print device is processed.

It is another aspect of the present invention to provide an image printing device which incorporates a pause capability, that is, which is able to pause the operation according to a user input while input data including a plurality of pages sent to the device is processed.

Additional aspects and/or advantages of the invention will be set forth in part in the description which follows and, in part, will be obvious from the description, or may be learned by practice of the invention.

The foregoing and/or other aspects are achieved by providing a method of operating an image printing device to receive input data and print images, including: generating output data to form an image by interpreting and processing the received input data; holding the printing of the images while a pause option input by a user is activated; and forming the image by using the output data and printing the formed image when the pause option is deactivated. The output data generating is performed even while the pause option is activated. The holding includes: determining whether a print cancel option is activated according to the user input, canceling the printing operation and deleting the input data from a memory when it is determined the print cancel option is activated; and holding the printing of the images until the pause option is deactivated when it is determined that the print cancel option is deactivated. Further, the generating of the output data includes generating the output data after receiving the input data and analyzing the received input data; determining whether there is a storage region in a memory for the output data and holding the printing of the images until the storage region is secured when no storage region is found; allocating the storage region to store the output data in the memory; and storing the output data in the storage region after generating the output data.

The foregoing and/or other aspects are also achieved by providing an image printing device including: a host interface unit to receive input data; a controller to interpret and process the input data received by the host interface unit and to generate output data to form an image; and an image generating unit to print the image formed according to the output data, wherein the image generating unit, according to control by the controller, waits before printing the image while a pause option is activated by a user input, and prints the image on a paper when the pause option is deactivated. The controller includes: a cancel option detecting module to determine whether a print cancel option is activated according to the user input; a print canceling module to delete the received input data and cancel the print operation when it is determined that the print cancel option is activated; and a print holding module which makes the operation of the image generating unit hold until the pause option is deactivated when it is determined that the print cancel option is deactivated. The image printing device further includes a predetermined memory, the controller determines whether there is a storage region to store the output data in the memory, and the memory stores the output data in the storage region as allocated by the controller. The image printing device further includes the manipulation panel generating the user input according to the user operation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart for illustrating the operation of an image printing device according to the conventional art;

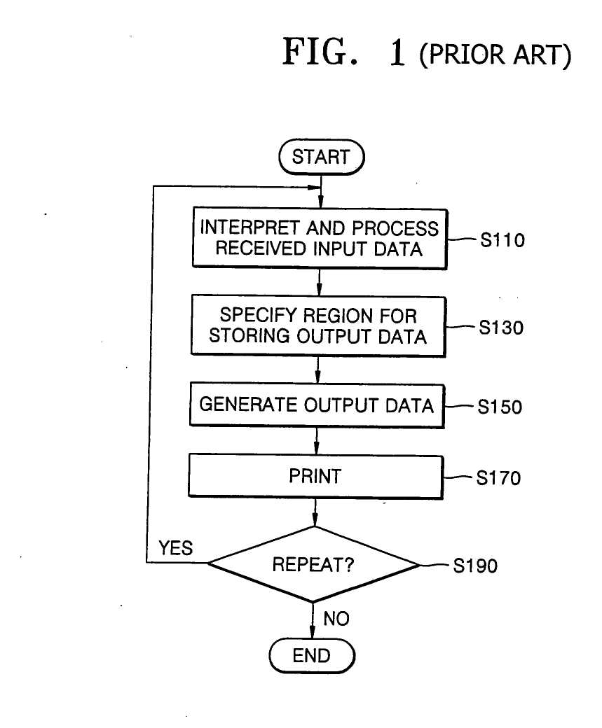

FIG. 2 is a flow chart for illustrating the operation of an image printing device according to an embodiment of the present invention;

FIG. 3 is a block diagram for showing the configuration of an image printing device according to the embodiment of the present invention; and

FIG. 4 conceptually shows the operation of the manipulation panel of FIG. 3.

### DETAILED DESCRIPTION OF THE PREFERRED EMBODIMENTS

Reference will now be made in detail to the embodiment of the present invention, an example of which is illustrated in the accompanying drawings, wherein like reference numerals refer to the like elements throughout. The embodiment is described below to explain the present invention by referring to the figures.

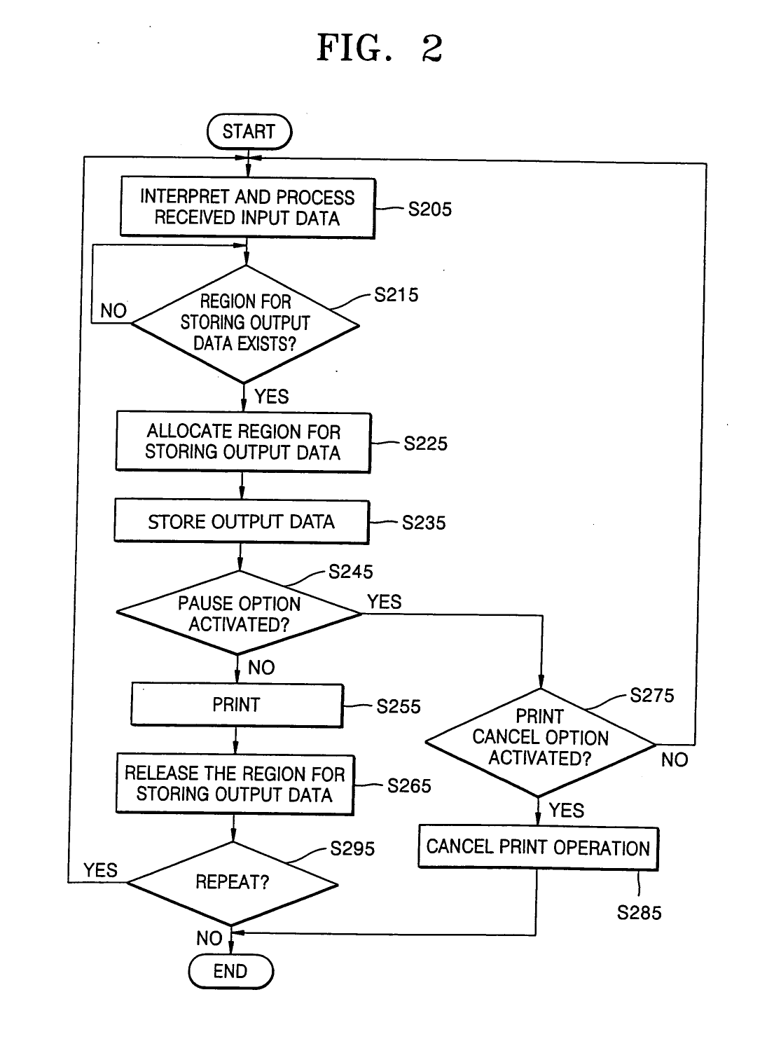

FIG. 2 is a flow chart for illustrating the operation of an image printing device according to an aspect of the present invention.

When input data is sent to the printing device by a user, a print operation is commenced. That is, the image printing device interprets and processes the input data received from the user (S205). The interpretation and process of input data can include generating an output file used to form images by interpreting input data which is an electronic file. Then, the image printing device determines whether there is a storage region where it can store the output data in the internal storage unit (S215). When it is determined that there is no room for the output data in the internal storage unit, the image printing device waits until the storage region is secured. On the other hand, when it is determined that there is room for the output data, it allocates the storage region for the output data (S225). Then, the generated output data is stored in the allocated storage region (S235).

The print operation using the stored output data is now commenced. It is determined whether a user activates a pause option before executing a print operation using output data (S245). When it is determined that the pause option is not activated, the output data is printed as in the case of the image print device according to the conventional art (S255). Then, the printed output data is deleted from the stored storage region and the allocated storage region is released (S265). It is possible that the output data is not deleted from the storage region when the output data is to be printed again.

On the other hand, when it is determined that the user activates the pause option, whether a print cancel option is activated is detected (S275). When it is detected that the user activated the print cancel option, the print operation is cancelled (S285) and finished. Then, the output data, which is stored in the allocated storage region before the print operation is cancelled, is deleted. When the user deactivates the print cancel option, it is determined that the user intends not to cancel the print operation, but to hold it temporally. Therefore, instead of printing the output data, the image printing device interprets and processes subsequent input data (S205). When the user deactivates the print cancel option, the image printing device may return to the determining operation (S245), and wait without interpreting the following input data. On the other hand, it is advantageous since the device can process the subsequent input data received from the user to generate output data when the printing device enters the step S205, that is, in case that the pause option is activated, it is preferable to process the input data ahead, as much as the internal storage region of the image printing device allows.

This process is repeated if the input data received from the user includes image data of a plurality of pages (S295).

The pause option activated by the user can be set both before and after the actual print operation begins. If the pause option is activated before the print operation is performed, the printing device does not proceed to print the received input data on paper. Rather, the print device generates the final output data to store and wait as much as the maximum storing is possible using the internal storage region (semiconductor memory such as RAM and ROM, or a storage device such as HDD). On the other hand, when the pause option is activated during performing the print operation, the image printing device terminates printing the output data on paper immediately and waits. In doing so, the image printing device processes the rest of the input data and generates the final output data. The image printing device keeps waiting until the user deactivates the pause option.

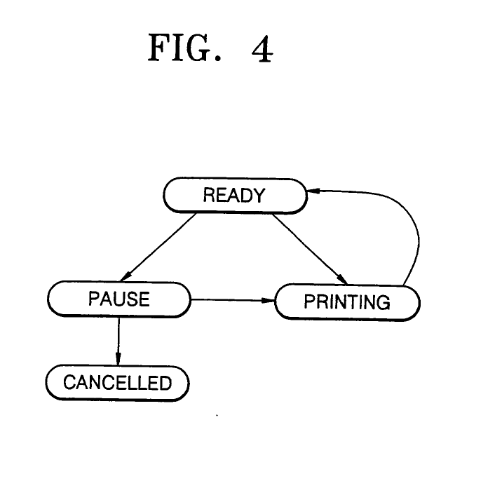

The user can operate the pause option directly through a manipulation panel of the image printing device. Furthermore, the user can adjust the pause option from the user's host through specified software performing functions like a network manager. Moreover, when the pause option is activated, the image printing device represents on the manipulation panel of the device that the pause option is activated at the moment, and notifies a remote program such as the network manager (see FIG. 4).

As shown in FIG. 2, the operating method of the image printing device according to the embodiment of the present invention can embody easily the pause capability without an additional hardware.

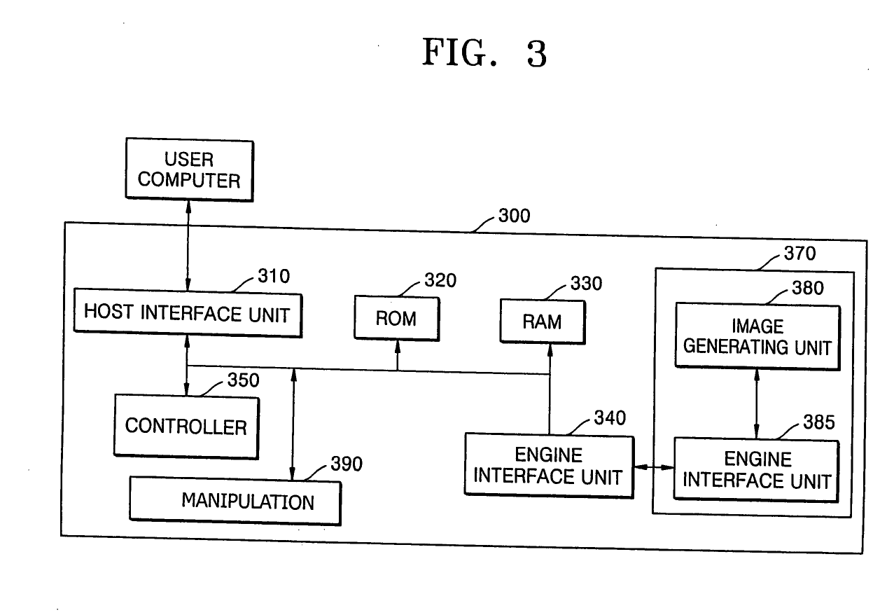

FIG. 3 is a block diagram for showing configuration of the image printing device to perform the method of FIG. 2. The image printing device 300 shown in FIG. 3 includes a semiconductor memory such as ROM 320 and RAM 330, a host interface unit 310 which performs communication with a user's personal computer, an engine 370 to print images, an engine interface 340, a controller 350 and a manipulation panel 390 to communicate with the image printing engine 370. The image printing engine 370 includes an engine interface 385 and an image generating unit 380.

The controller 350 included in the image printing device 300 shown in FIG. 3 interprets and processes the input data received by the host interface unit 310, and generates the output data to form images. The output data generated by the controller 350 is printed on sheets of paper by the image generating unit 380. Also, the image generating unit 380 waits under the control of the controller 350 before printing the image while the pause option is activated by the user input, and When the pause option is deactivated, it prints the image on paper. The controller 350 generates the output data, even while the pause option is activated, and stores the output data in the semiconductor memory such as the ROM 320 and/or the RAM 330.

Furthermore, the controller 350 included in the image printing device 300 shown in FIG. 3 includes a cancel option detecting module (not shown), a print canceling module (not shown), and a print holding module (not shown). The cancel option detecting module detects whether the print cancel option is activated according to the user input. When it is determined that the print cancel option is activated as a result of the detection of the cancel option detecting module, the print canceling module deletes the received input data and cancels the print operation. When it is determined that the print cancel option is deactivated as a result of the detection of the cancel option detecting module, the print holding module holds the image generating unit until the pause option is deactivated. Modules such as the cancel option detecting module, the print canceling module, and the print holding module can be embodied as specific devices in the controller 350, or can be embodied as software executed in the controller 350.

The manipulation panel 390, according to the user's manipulation, generates the user input which activates and deactivates the pause option or the print cancel option. Users can easily manage the print operation by manipulating the manipulation panel 390.

FIG. 4 conceptually shows the operation represented on the manipulation panel 390 of the image printing device 300.

First, the image printing device 300 enters into a READY state when it is turned on. The READY can mean either a status before receiving the input data from a user or a status until the output data is yet to be generated right after the input data is received.

When the output data is generated from the received input data, the image printing device enters a PRINTING or PAUSE state based on activation/deactivation of the pause option from the user. In the PRINTING state, the image printing device prints following pages sequentially when the print of a page is not finished, while it goes back to the READY state when the final page of the output data is printed. However, when it is in a PAUSE state, the image printing device waits for an additional input from the user. When the user deactivates the pause option, the image printing device enters a PRINTING state. But, when the user cancels the print operation, the image printing device enters a CANCELLED state, and deletes all received input data and the generated output data to finish the print operation permanently.

According to the embodiment of the present invention there is a method of enabling the image printing device to wait, while the input data including a plurality of pages transmitted to the image printing device is processed and printed out.

Furthermore, disclosed is an image printing device which enables the user to easily make the device wait without printing while the input data including a plurality of pages is being inputted.

Moreover, the user can temporarily stop temporarily the on-going print operation of papers including a plurality of the pages.

Although an embodiment of the present invention has been shown and described, t would be appreciated by those skilled in the art that changes may be made in this embodiment without departing from the principles and spirit of the invention, the scope of which is defined in the claims and their equivalents.

1. A method of operating an image printing device to receive input data and print an image, the method comprising:
generating output data to form the image by interpreting and processing the received input data;
holding the printing of the image while a pause option input by a user is activated; and
forming the image by using the output data and printing the formed image when the pause option is deactivated,
wherein the generating of the output data is performed even while the pause option is activated.

2. The method of claim 1, wherein the holding comprises:
determining whether a print cancel option is activated according to the user input;
canceling the printing of the image and deleting the input data from a memory when it is determined that the print cancel option is activated; and
holding the printing of the image until the pause option is deactivated when it is determined that the print cancel option is deactivated.

3. The method of claim 1, wherein the generating of the output data comprises:
generating the output data after receiving the input data and analyzing the received input data;
determining whether there is a storage region in a memory for the output data and waiting until the storage region is secured when it is determined that there is no storage region;
allocating the storage region to store the output data in the memory; and
storing the output data in the storage region after generating the output data.

4. The method of claim 1, further comprising operating a manipulation panel included in the image printing device to generate the user data.

5. An image printing device comprising:
a host interface unit to receive input data;
a controller to interpret and process the input data received by the host interface unit and to generate output data to form an image; and
an image generating unit to print the formed image according to the output data, wherein the image generating unit, according to control by the controller, waits before printing the image while a pause option is activated by a user input, and prints the image on a paper when the pause option is deactivated,
wherein the controller generates the output data even while the pause option is activated.

6. The image printing device of claim 5, wherein the controller comprises:
a cancel option detecting module to determine whether a print cancel option is activated according to the user input;
a print canceling module to delete the received input data and cancel the print operation when it is determined that the print cancel option is activated; and
a print holding module which holds the printing by the image generating unit until the pause option is deactivated when it is determined that the print cancel option is deactivated.

7. The image printing device of claim 5, wherein the device further comprises a memory, and the controller determines whether there is a storage region in the memory to store the output data, and the memory stores the output data in the storage region as allocated by the controller.

8. The image printing device of claim 5, further comprising a manipulation panel to generate the user input according to a user operation.

9. A method of forming an image with an image forming apparatus, comprising:
inputting data relating to the image;
generating output data from the input data;
printing the image from the output data; and
pausing the printing during the generating of the output data.

10. The method of claim 9, wherein the generating of the output data comprises:
determining whether there is room for the output data in a storage unit; and
pausing the generating of the output data until there is room in the storage unit for the output data if not determined that there is room.

11. The method of claim 9, further comprising:
canceling the printing during the pausing of the printing.

12. The method of claim 9, wherein the pausing of the printing during the generating of the output data comprises generating the output data from the input data input after the pausing.

13. The method of claim 9, wherein the pausing occurs before the printing.

14. The method of claim 9, wherein the pausing occurs during the printing.
